(19) United States
(12) Patent Application Publication
(10) Pub. No.: US 2014/0367602 A1
(43) Pub. Date: Dec. 18, 2014

(54) VALVE MEMBER WITH COMPOSITE SEAL

(71) Applicant: Smith International, Inc., Houston, TX (US)

(72) Inventors: Sean A. Filipow, Houston, TX (US); Manjinder Singh, Corona, CA (US)

(21) Appl. No.: 14/302,101

(22) Filed: Jun. 11, 2014

Related U.S. Application Data
(60) Provisional application No. 61/834,358, filed on Jun. 12, 2013.

(51) Int. Cl. F16K 1/46

(52) U.S. Cl. CPC F16K 1/465
USPC 251/358

(57) ABSTRACT

Valve members include a metal he body having a head. with a circular-shaped side section extending axially therefrom. A composite seal is adjacent the side section, and extends circumferentially therearound. The composite seal has an elastomeric body with an inner diameter in contact with the side section, and an outside surface extending away from the side section. A non-elastomeric material is attached to the elastomeric body.

### CROSS-REFERENCE TO RELATED APPLICATION

This patent application claims priority to and the benefit of U.S. Provisional Patent Application 61/834,358, filed on Jun. 12, 2013, which is hereby incorporated by reference in its entirety.

### BACKGROUND

A variety of different types of valves are known in the art and are generally used for the purpose of controlling the flow of a gas and/or fluid within a particular gas or fluid flow or transport system. One type of such known valves is a poppet valve that includes a valve body having one or more fluid inlets and fluid outlets, a valve seat disposed within the body, and a movable poppet member disposed within the body. Fluid flow through the valve is affected by the placement position of the poppet member within the valve body relative to the valve seat.

For example, the poppet valve may be configured such that fluid flow through the valve body is elected by moving the poppet member from a closed position, where a portion of the poppet member is positioned or seated against the valve seat, to an open position, where the poppet member is moved relative to the valve seat to become unseated to thereby permit the flow of fluid through the valve. Poppet valves can be configured differently to address different system flow requirements, e.g., in an example embodiment fluid flow through a valve may instead occur when the poppet member is seated against the valve seat.

Poppet valves known in the art are constructed having a poppet member including an elastomeric material disposed along a surface portion of the poppet member that is located adjacent the valve seat for the purpose of providing an improved degree of sealing when the poppet member is positioned against the valve seat. While poppet valves including a poppet member constructed in such manner may provide an improved degree of sealing as contrasted with a purely metallic poppet member, when subjected certain aggressive fluid-transport services such as slurry service, i.e., liquid transport service comprising intermixed fluid and a solid constituents and the like, the elastomeric material of such poppet valves may undergo abrasion wear and/or stress cracks from repetitive cycling of being seated and unseated during valve operation, which abrasion wear and/or stress cracks may eventually result in a failure that reduces the effective valve service life.

### SUMMARY

According to some embodiments, valve members have a rigid body having a head at one end having a circular-shaped side section extending axially from the head. A composite seal element is adjacent the side section, and extends circumferentially therearound. The composite seal element includes an elastomeric body having an inner diameter that is in contact with the side section, and having an outside surface extending away from the side section. The composite seal includes a non-elastomeric material that is attached with at least a portion of the elastomeric body outside surface.

In some embodiments, the non-elastomeric material is a fabric material. In an example, the non-elastomeric material is attached along a portion of the elastomeric body outside surface that is positioned to make contact with a valve seat within a valve body and/or may be attached along a portion of the outside surface that does not make contact with the valve seat within a valve body.

The non-elastomeric material may have a constant thickness along the outside surface, or may have a thickness that is different depending on the placement position along the outside surface. In an example, the non-elastomeric material is provided in the form of a fabric that is integrally bonded with the elastomeric body. The fabric may be provided in one or more layers disposed on or in the body. In an example, the elastomeric material is urethane, and the non-elastomeric material is a fabric including aramid fiber. In an example, the non-elastomeric material covers at least 25 percent of the outside surface. In an example, the non-elastomeric material has a thickness greater than about 0.1 mm or in the range of from about 0.2 to 1 mm.

According to some embodiments, valve members have an improved degree of service life by improving a degree of wear resistance at the sealing surface and/or by providing an improved degree of support and rigidity to the elastomeric body at or adjacent to the sealing surface.

### BRIEF DESCRIPTION OF THE DRAWINGS

These and other features and advantages of valves and valve members as disclosed herein will be appreciated as the same becomes better understood by reference to the following detailed description when considered in connection with the accompanying drawings wherein:

FIG. 1 illustrates a cross-sectional side view of a section of an example pump valve including two prior art valve members disposed therein;

FIG. 2 is a perspective view of a prior art valve member;

FIG. 3 is a cross-sectional side view of the prior art valve member of FIG. 2;

FIG. 4 is a cross-sectional side view of a section of an example valve member as disclosed herein;

FIGS. 5A and 5B are cross-sectional side views of an example valve member and a section of an example valve member, respectively, as disclosed herein;

FIGS. 6A and 6B are cross-sectional side views of an example valve member and a section of an example valve member, respectively, as disclosed herein;

FIGS. 7A and 7B are cross-sectional side views of an example valve member and a section of an example valve member, respectively, as disclosed herein; and

FIG. 8 is a cross-sectional side view of a section of an example valve member as disclosed herein.

### DETAILED DESCRIPTION

Valve members as disclosed herein may be used in a number of different types of valves, e.g., where the valve member is disposed movably therein to engage a valve seat for the purpose of controlling fluid flow within the valve. In an example, the valve member is a poppet member, e.g., having a metallic body, having a circular outside surface that is configured for placement against a circular seat within the valve body. The outside surface includes a composite seal element disposed therealong (e.g., the composite seal is adjacent to the outside surface of the valve member), where the composite seal element includes a non-elastomeric material, e.g., in the form of a fabric material, joined with an elastomeric body, e.g., disposed along at least a portion of the body outside surface.

The fabric material can be positioned along the entire outside surface or a portion of the body outside surface, and the fabric material may have a constant thickness or a variable thickness depending on location along the outside surface. In some embodiments, valve members as disclosed herein have an improved level of wear resistance and/or resistance to cracking when placed into use, thereby having an improved effective service life.

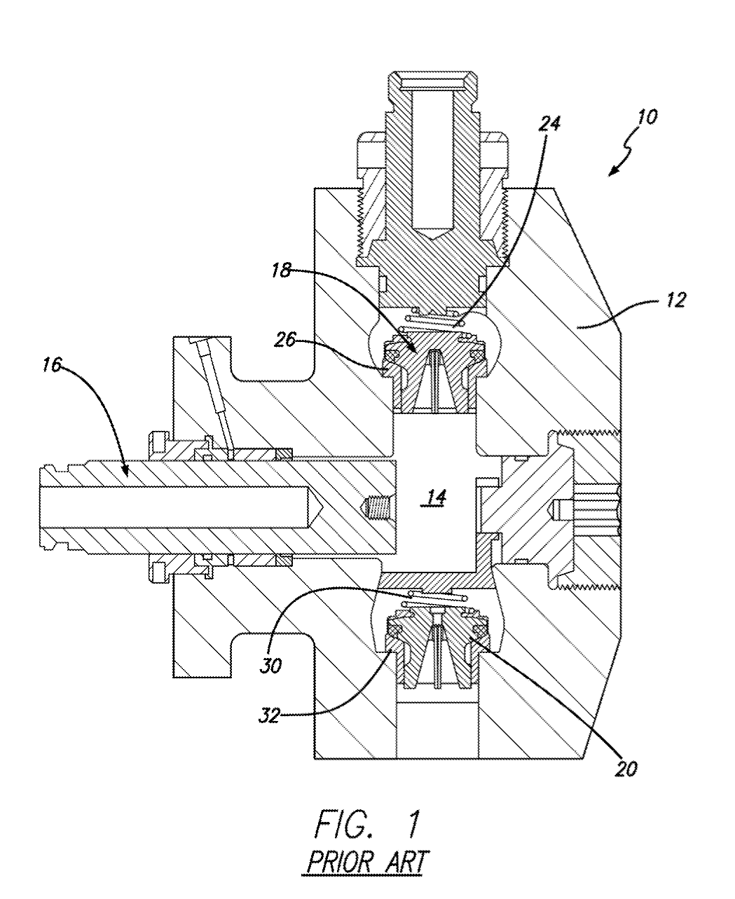

Poppet valve members are used in a variety of different types of valves and valve applications. For example, poppet valve members may be used in MacClatchie valves, which are pump valves used in conjunction with a reciprocating piston pump to effect fluid transport. FIG. 1 illustrates a cross-sectional view of a section 10 of such an example pump valve including a body 12 having a fluid-transport channel 14 disposed therein, and a reciprocating piston 16 in fluid-flow communication with the channel 14.

A pair of poppet valve members 18 and 20 is positioned within the fluid-transport chamber 14 to provide fluid transport through the valve in response to the movement of the piston 16. A first valve member 18 is located at an upper end of the channel 14, and is biased by a spring 24 into seated engagement with a first valve seat 26 that is fixedly attached to the channel. A second valve member 20 is located at a lower end of the channel 14, and is biased by a spring 30 into seated engagement with a second valve seat 32 that is fixedly attached to the channel.

Arranged in this manner, movement of the piston 16 outwardly away from the channel 14 causes the second valve member 20 to move upwardly against the spring bias to become unseated from the second valve seat 32 and permit the passage of fluid into the channel 14. While a reversed movement of the piston 16 inwardly into the channel 14 causes the second valve member 20 to be seated against the second valve seat 32, and causes the first valve member 18 to move upwardly against the spring bias to become unseated from the first valve seat 26 and permit the passage of fluid outwardly from the channel 14. The valve members 18 and 20 illustrated in FIG. 1 are known in the art and include an elastomeric sealing element disposed along an outer surface of the valve member for seating against the respective first and second valve seats 26 and 32.

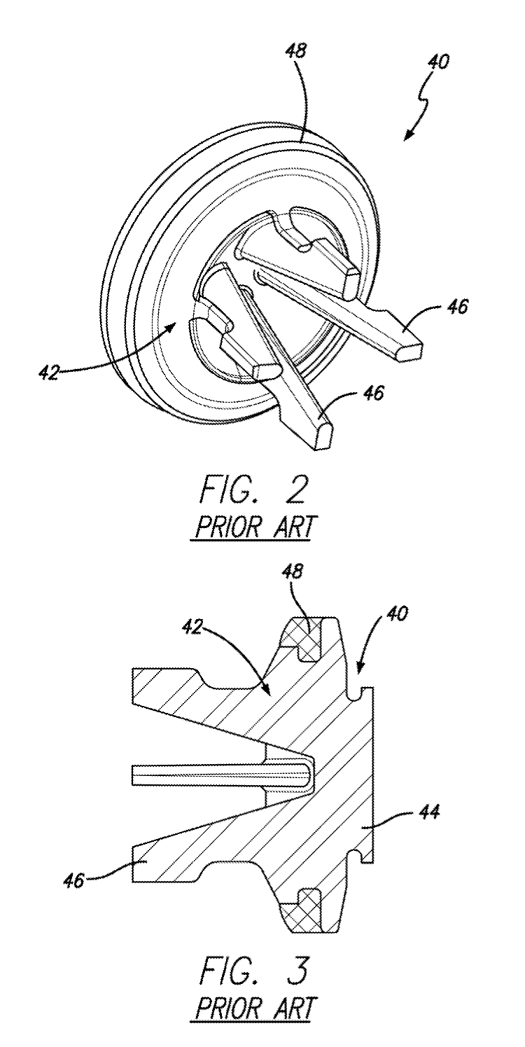

FIGS. 2 and 3 show the prior an valve member 40 illustrated in FIG. 1, including a metallic body 42 having a circular head 44 at one end, and having a number of legs 46 projecting axially a distance away from the head. As illustrated, the valve member 40 also includes an elastomeric seating element 48 that is disposed circumferentially around a portion of the head at a location designed to engage a valve seat when placed within a valve body. In such a prior art valve member, the elastomeric sealing element has a unitary or one-piece construction formed entirely of an elastomeric material, i.e., it contains no other non-elastomeric material or element.

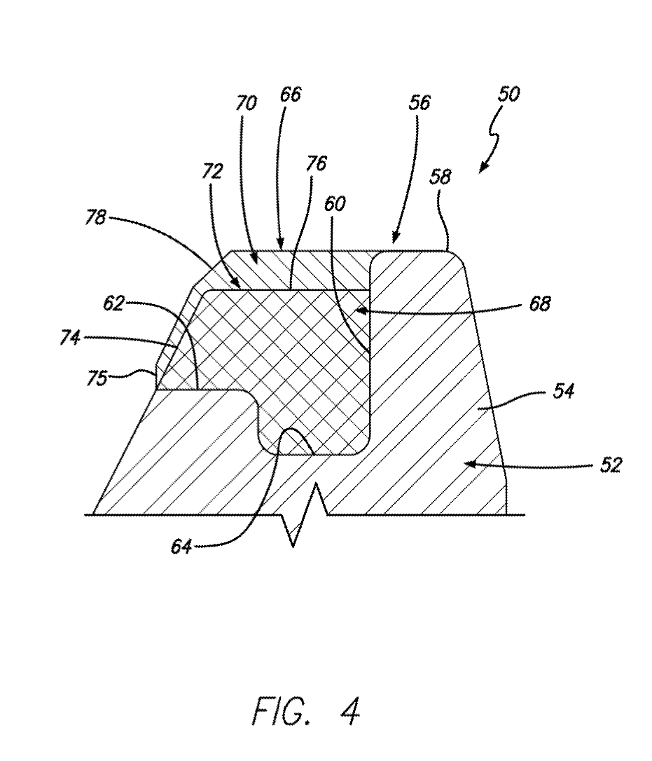

FIG. 4 shows a section of an example valve member 50 as disclosed herein having a body 52 having a circular head 54 at one end and a number of legs (not shown) projecting axially therefrom and extending to an opposite end. The valve member may be made of a metal material. It is to be understood that the body can be configured differently depending on the particular construction of the valve and/or particular valve end-use application. The body includes a side section 56 that is interposed axially between the head and the legs, and that extends circumferentially around the body.

Moving from right to left in FIG. 4, the side section 56 includes a first diameter section 58, a grooved section 60, and then a second diameter section 62, where the second diameter section 62 is sized less than the first diameter section 58, and where the grooved section 60 includes a wall section 64 having a diameter that is less than both the first and second diameter sections, thereby forming a recessed groove therebetween.

In an example, the side section 56 is configured in this manner to both accommodate placement of a circular composite seal element 66 as disclosed herein therewith, and to position the composite seal element at a location for making contact with a valve seat within a valve. The composite seal element 66 as disclosed herein includes an elastomeric body 68 and a non-elastomeric material 70 disposed along an outside surface 72 of the elastomeric body 68. In some embodiments, elastomeric materials useful for forming the elastomeric body include polymers capable of undergoing a desired amount of elastic deformation to provide a leak-tight seal with a valve seat. Suitable elastomeric materials include nitrile, highly saturated nitrile, carboxylated nitrite, natural rubber, fluoropolymer, urethane, or combinations thereof.

In some embodiments, materials useful for forming the non-elastomeric layer include materials capable of providing an improved degree of abrasion resistance to the underlying elastomeric body, and/or that are also capable of providing a degree of support or rigidity to the elastomeric body. Suitable non-elastomeric materials suitable include those provided in the form of a fabric selected from the group including and not limited to those formed from aramid fibers, such as Kevlar, cotton, nylon, polyester, or combinations thereof.

In an example, the non-elastomeric material is a fabric material that is impregnated with the elastomeric material used to form the body, and is bonded to an outside surface of the elastomeric body during a molding process used to form the composite seal element 66. Thus, the resulting composite seal element 66 is one where the fabric material is integrally bonded together with the underlying elastomeric body.

The placement position of the fabric material in the composite seal element and/or the thickness of the fabric material on the elastomeric body may vary depending on the particular valve member construction, the types of elastomeric and fabric materials being used, the type of valve being used, and/or the valve end-use application. For example, the fabric, material may be positioned along the composite seal element at a location that directly engages a valve seat, e.g., for applications calling for increased abrasion resistance, such as applications where the fluid being transported through the valve is a slurry including both fluid and solid constituents. In another example, the fabric material may be placed at a location that directly engages a valve seat, e.g., for valve applications calling for an increased level of protection against crack development in the underlying elastomeric body seal. In another example, the fabric material may he positioned along the composite seal element at a location that does not directly contact the valve seat, e.g., for applications calling for an increased level of rigidity or support of the elastomeric body. Further, if desired, the fabric material may be positioned along the body at a position that is not on the body outside surface, e.g., for the purpose of providing a desired degree of support and or rigidity to the body at a particular location. Additionally, the fabric material can he placed in any combination of the above-noted locations.

In an example where the fabric seal is disposed along an outside surface of the body, the fabric material may cover at least about 25 percent of the elastomeric body outside surface, in the range of from about 25 to 100 percent, or in the range of from about 50 to 100 percent of the elastomeric body outside surface.

The fabric material may have a thickness that is constant within the composite seal element, or that varies depending on the placement position along the composite seal element. In an example, the fabric material may have a thickness of greater than about 0.1 mm, in the range of from about 0.2 to 1 mm, from about 0.3 to 0.5 mm, or in the range of from about 0.35 to 0.45 mm The desired thickness may be provided in the form of a single layer of the fabric material and/or through the use of two or more fabric material layers (as better described below and illustrated in FIG. 8).

Referring still to FIG. 4, the composite seal element 66 of this example includes a fabric material 70 that extends along the entire outer surface 72 of the underlying elastomeric body 68. Moving from left to right, the fabric material 70 extends along a bottom section 74 of the elastomeric body outer surface 72, continues along, the entire side section 76, and ends at the first diameter section 58. As illustrated, the bottom section 74 extends towards the side section 76 at an angle. In this example, the bottom section 74 extends at an angle that is configured to coincide with the geometry the conical surface of the valve seat on which the elastomeric composite seal element will engage. In the particular example illustrated in FIG. 4, the angle of the bottom section 74 is approximately 25 degrees (relative to an axis that is perpendicular to the side section 72). It is to be understood that the angle of the bottom section may vary depending on the geometry of the valve seat

Accordingly, while a particular angle of departure at this position has been disclosed, it is to he understood that valve members as disclosed herein may have a fabric material that does not have an angle of departure at this location, or that has one that is other than that illustrated in this example. In some embodiments, the fabric material 70 has a tapered transition 75 starting at a lower-most edge of the bottom section 74, and has a constant thickness along a remaining portion of the bottom section. For example, the thickness of the fabric material along the bottom section is within the ranges noted above, e.g., approximately 0.42 mm.

The fabric material 70 disposed along the side section 76 has a generally constant thickness extending from a tapered transition 78 at a side section leading edge. In this example, the tapered transition has an angle of departure (as measured relative to an axis that is perpendicular to the side section 76) of approximately 45 degrees. In some embodiments, having an angle of departure at this location is desired to create a squeegee-like wiping effect. As the elastomeric composite is compressed, the portion of the elastomeric with the lesser angle contacts the mating valve geometry first, pushing any slurry between the components toward the outside diameter (“OD”) of the valve. The higher-angle area starts to seal as compression continues, further pushing slurry toward the OD. Accordingly, while a particular angle of departure at this position has been presented, it is to be understood that valve members as disclosed herein may have a fabric material that does not have an angle of departure at this location, or that has an angle of departure that is different than that illustrated in this particular example. In some embodiments, the fabric material 70 along the side section has a thickness of approximately 0.8 mm. Placement of the fabric material along the side section 76, and the relatively thicker layer of the fabric material along this section, may operate to provide additional rigidity to the underlying elastomeric body to thereby resist damage that may be caused by repeated contact. with a. valve seal.

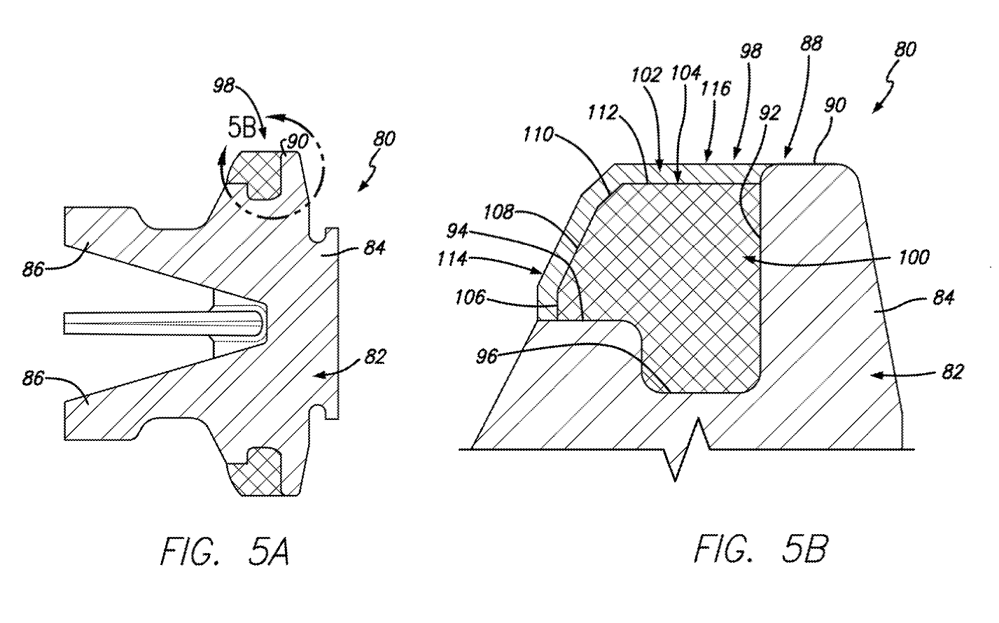

FIGS. 5A and 5B illustrate a valve member 80 according to embodiments of the present Disclosure. The valve member 80 is a metallic body 82 having a circular head 84 at one end and a number of legs 86 projecting axially therefrom to an opposite end. It is to be understood that the body 82 can be configured differently depending on the particular construction of the valve it will be used with, and/or the particular valve end-use application. The body includes a side section 88 that is interposed between the head and legs, and that extends circumferentially therearound. The side section 88 has a first diameter section 90, a recessed grooved section 92, and a second diameter section 94, where the second diameter section 94 is sized less than the first diameter section 90, and where the recessed grooved section includes a wall section 96 having a diameter that is less than both the first and second diameter sections.

As noted above for the example valve member illustrated in FIG. 4, the side section 88 is configured to both accommodate placement of a circular composite seal element 98 therewith, and to position the composite seal element, at a location fir making contact with a valve seat within a valve. The composite seal element 98 has an elastomeric body 100 and a fabric material 102 disposed along an outside surface 104 of the elastomeric body 100. The elastomeric body and fabric material may be formed from the same materials noted above for the example illustrated in FIG. 4.

Referring to FIG. SB, the elastomeric body 100 for this embodiment is configured differently from that disclosed above and illustrated in FIG. 4. Specifically, moving, left to right, the elastomeric body 100 is configured having an outside surface 104 having four sections. Namely, a first section 106 projecting radially outwardly from the valve body second diameter section 94 at an angle (e.g., a 90 degree angle), a second section 108 extending from the first section at an angle, e.g., of approximately 25 degrees relative to the first section 106, a third section 110 extending from the second section at an angle, e.g., of approximately 45 degrees relative to the first section 106, and a fourth section 112 extending from the third section to the first diameter section 90 and having an orientation that is about perpendicular to the first section. In this example, the second and third sections 108 and 110 serve as the transition between the first and fourth sections that respectively form a bottom section 114 and a side section 116 of the composite seal member. According to some embodiments, the sections may be distinct sections having sharp transitions (as shown in FIG. 5B), but in still other embodiments, one or more sections may transition into one another. For example, the sections may transition into one another using a radius.

Specifically, the second section 108 is provided at the above angle of departure to coincide with the geometry of the conical surface on the valve seat, on which the elastomeric composite member will contact and seal. Specifically, the third section 110 is provided at about the above angle of departure for the purpose of creating a squeegee-like wiping effect. As the elastomeric composite member is compressed, the portion of the elastomeric member with the lesser angle contacts the mating geometry first, pushing any slurry between the components toward the OD of the valve. The higher angle area starts to seal as compression continues, further pushing slurry toward the OD. While particular angles of departure have been noted for sections 108 and 100 for the example illustrated in FIG. 5, it is to be understood that the angles for these sections may vary depending on the specific geometry of the valve.

As shown in FIG. 5B, the fabric material 102 may be provided over the entire outside surface 104 of the elastomeric body 100 and follows the configuration of the body 100 as disclosed above. As shown in FIG. 5B, the fabric material may have a constant thickness along the entire outside surface of the elastomeric body, e.g., within the ranges noted above, and in some embodiments, the thickness may be approximately 0.42 mm. However, composite valve members as disclosed herein may have a thickness that is greater than or less than 0.42 mm, which thickness may he influenced by factors that include, and are not limited to, the type of elastomeric material used to form the elastomeric body, the type of material used to form the fabric layer, the configuration of the elastomeric body, and the type of valve and valve end-use application.

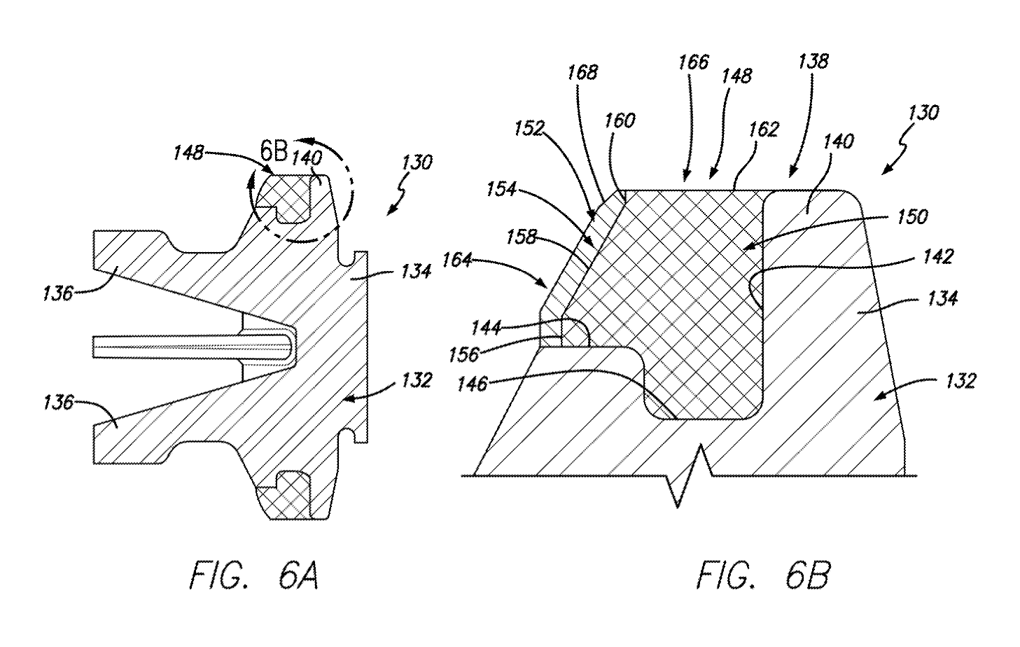

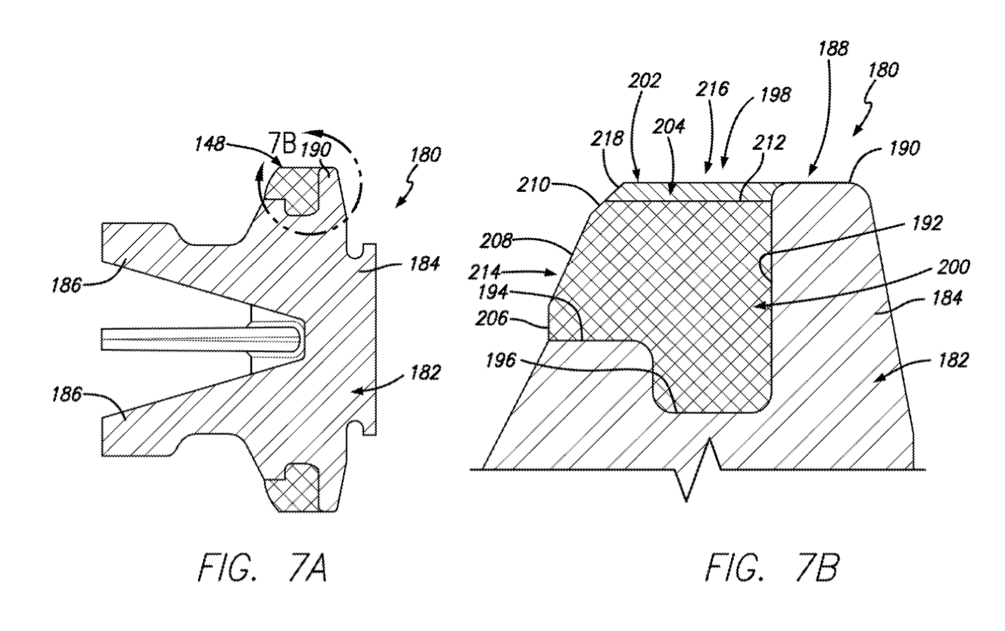

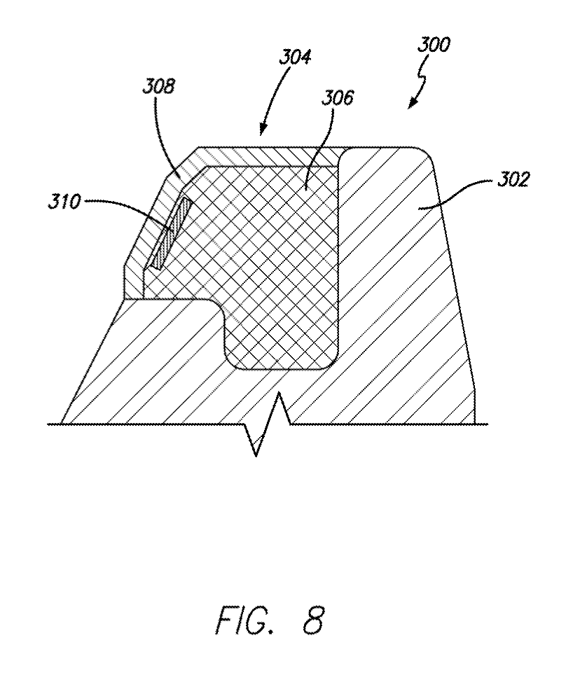

FIGS. 6A and 6B illustrate an example valve member 130 as disclosed herein. The valve member 130 has a body 132 (e.g., a metallic body) having a circular head 134 at one end and a number of legs 136 projecting axially therefrom to an opposite end. It is to he understood that the body 132 may he configured differently depending on the particular construction of the valve it will be used with, and/or the particular valve end-use application. The body includes a side section 138 that is interposed between the head and legs, and that extends circumferentially therearound. The side section 138 has a first diameter section 140, a recessed grooved section 142, and a second diameter section 144, where the second diameter section 144 is sized less than the first diameter section 140, and where the recessed grooved section includes a wall section 146 having a diameter that is less than both the first and second diameter sections.

As noted above for the valve member illustrated in FIG. 4, the side section 138 may be configured to both accommodate placement of a circular composite seal element 148 therewith, and to position the composite seal element at a location for making contact with a valve seat within a valve. The composite seal element 148 has an elastomeric body 150 and a fabric material 152 disposed along an outside surface 154 of the elastomeric body 150. The elastomeric body and fabric material may be formed from the same materials noted above for the embodiment illustrated in FIG. 4.

Referring to FIG. 6B, the elastomeric body 150 is different than that disclosed above and illustrated in FIGS. 4, 5A, and 5B. Specifically, moving left to right, the elastomeric body 150 is configured having an outside surface 154 having four sections. Namely, a first section 156 projecting radially outwardly from the valve body second diameter section 144 at an angle, e.g., a 90 degree angle, a second section 158 extending from the first section at an angle, e.g., of approximately 25 degrees relative to the first section 156, a third section 160 extending from the second section at an angle, e.g., that is approximately parallel to the first section 156, and a fourth section 162 extending from the third section to the first diameter section 140 and having an orientation that is perpendicular to the first section. In this example, the second section 158 provides a transition between from a bottom section 164 and a side section 166 of the composite seal member.

Specifically, the second section 158 is provided at the above angle of departure to coincide with the geometry of the conical surface on the valve seat, on which the elastomeric composite member will seal. Thus, it is to be understood that the particular angle of departure for the second section 158 may vary depending on the geometry of the particular valve with which the valve member will be used.

As shown in FIG. 6B, the fabric material 152 is provided over only a portion of the elastomeric seal outside surface 154, following along the elastomeric body first and second sections 156 and 158. As shown in FIG. 6B, the fabric material 152 may not be provided along the fourth section 162 of the elastomeric body forming the side section 166. In addition, the fabric material 152 may include a tapered section 168 that extends between the underlying second and third sections 158 and 160 of the elastomeric body outer surface. The tapered section 168 may be at an angle of approximately 45 degrees relative to the first section 156 so that the fabric material coverage terminates at the intersection between the elastomeric body third and fourth sections.

In this embodiment, the fabric material is placed only along the bottom section 164 and not along the side section 166, e.g., for providing a desired degree of protection to the underlying elastomeric material at and immediately adjacent to where the composite seal member will make contact with a valve seat, and in a valve application where additional support or reinforcement (e.g., from placement of the fabric material along the side section) is not needed.

The fabric material is provided in this embodiment having a constant thickness along the outside surface of the elastomeric body (except for the tapered section 168), and the thickness of the fabric material is within the range noted above, and in some embodiments, may be approximately 0.42 mm. While a particular fabric material layer thickness has been disclosed, it is to be understood that composite valve members as disclosed herein may have a thickness that is greater than or less that this particular thickness, which thickness may be influenced by factors that include, and are not limited to, the type of elastomeric material used to form the elastomeric body, the type of material used to form the fabric layer, the configuration of the elastomeric body, and the type of valve and valve end-use application.

FIGS. 7A and 7B illustrate an example valve member 180 as disclosed herein. The valve member 180 has a metallic body 182 having a circular head 184 at one end and a number of legs 186 projecting axially therefrom to an opposite end. It is to be understood that the body 182 may be configured differently depending on the particular construction of the valve it will he used with, and/or the particular valve end-use application. The body includes a side section 188 that is interposed between the head and legs, and that extends circumferentially therearound. The side section 188 has a first diameter section 190, a recessed grooved section 192, and a second diameter section 194, where the second diameter section 194 is sited less than the first diameter section 190, and where the recessed grooved section includes a wall section 196 having a diameter that is less than both the first and second diameter sections.

The side section 188 may be configured to both accommodate placement of a circular composite seal element 198 therewith, and to position the composite seal element at a location for making contact with a valve seat within a valve. The composite seal element 198 includes an elastomeric body 200 and a fabric material 202 disposed along an outside surface 204 of the elastomeric body 200 for disposed inside the elastomeric body 200 at an outside portion of the elastomeric body). The elastomeric body and fabric material may be formed from the same materials noted above for the other embodiments.

The elastomeric body 200 of FIGS. 7A and 7B is different than that disclosed above and illustrated in FIGS. 4, 5A, 5B, 6A and 6B. Specifically, moving left to right, the elastomeric body 200 is configured having an outside surface 204 including four sections. Namely, a first section 206 projecting radially outwardly from the valve body second diameter section 194 at an angle, e.g., a 90 degree angle, a second section 208 extending from the first section at an angle, e.g., of approximately 25 degrees relative to the first section 206, a third section 210 extending from the second section at an angle, e.g., of approximately 45 degrees relative to the first section 206, and a fourth section 212 extending from the third section to the first diameter section 190 and having an orientation that is approximately perpendicular to the first section. In this example, the second and third sections 208 and 210 provide a transition between a bottom section 214 and a side section 216 of the composite seal element.

Specifically, the second section 208 may be provided at the above described angle of departure to coincide with the geometry of the conical surface on the valve seat, on which the elastomeric composite member will seal. The third section 210 may be provided at the above described angle of departure for the purpose of creating a squeegee-like wiping effect. As the elastomeric composite member is compressed, the portion of the elastomeric member with the lesser angle contacts the mating geometry first, pushing any slurry between the components toward the OD of the valve. The higher angle area starts to seal as compression continues, further pushing slurry toward the OD. It is to be understood that the second and third sections may be configured having angles of departure other than noted depending on the particular configuration of the valve that the valve member will be used with.

In this embodiment, the fabric material 202 is provided over only a portion of the elastomeric seal outside surface 204, following along the elastomeric body fourth section 212. As shown in FIG. 7B in this embodiment, the fabric material 202 is not provided along the first, second or third sections of the of the elastomeric body forming the bottom section 214. The fabric material 202 of FIG. 7B includes a tapered section 218 extends a short distance from an intersection of the underlying third and fourth sections 210 and 212 of the elastomeric body outer surface The tapered section 218 is provided at an angle of approximately 45 degrees relative to the first section 206.

In some embodiments, the fabric material is placed only along the composite seal member side section 216 for providing a desired degree of support and/or rigidity to the underlying elastomeric material in a valve application where added abrasion resistance at a point of contact with the valve seat (e.g., from placement of the fabric material along the bottom section) is not needed.

The fabric material is provided in this embodiment may have a constant thickness along the outside surface of the elastomeric body (except for the tapered section 218) that is within the range noted above, and in some embodiments, may be approximately 0.42 mm. While a particular fabric material layer thickness has been disclosed, it is to be understood that composite valve members as disclosed herein may have a thickness that is greater than or less that this particular thickness, and the thickness may be selected by considering factors that include, but are not limited to, the type of elastomeric material used to form the elastomeric body, the type of material used to form the fabric layer, the configuration of the elastomeric body, and the type of valve and valve end-use application.

FIG. 8 illustrates an example valve member 300 that is somewhat similar to that illustrated in FIG. 5B as disclosed above, having a metal body 302 (e.g., a steel body) and a composite seal member 304. While this embodiment also includes elastomeric body 306 and a fabric material 308 disposed along an outside surface of the body, unlike the example illustrated in FIG. 5B, this example includes an additional fabric material later 310 disposed in the body. Accordingly, composite seal members as disclosed herein may include one or more layers of fabric material, where such other layer or layers of fabric material may positioned within the body as called for by a particular end-use application. For example, the additional fabric material layer may be positioned beneath a fabric material layer disposed along an outside surface of the body, e.g., to provide a further level of wear resistance should the top material layer become damaged. Such other layer of fabric material may also he positioned within the body in a manner that provides support and/or rigidity to the body and/or that may operate to blunt or otherwise stop the propagation of any cracks or tears that may exist in the body. Depending on the particular purpose and/or placement position of the additional fabric layer, such fabric layer may be in direct contact with another fabric layer or may be isolated therefrom by a section of the body 306. Additionally, it is to be understood that the thickness of such additional fabric material may be the same or different from that of another fabric material layer in the composite seal (and that thickness may be within the above described thicknesses of the fabric material). Furthermore, the additional fabric material may be the same or different than the fabric material 308 (e.g., they may each be made from different types of fabric materials). In addition, while the additional fabric material was shown in FIG. 8 in combination with an embodiment where the fabric material 308 is disposed along an entire outside surface of the body 306, one or more additional fabric material portions may also be used with any configuration of fabric material 308, e.g., any of those embodiments described above or shown in FIGS. 4-7B.

While valve members including composite seal member constructions as disposed herein have been discussed with reference to specific illustrations, it is to be understood that valve composite seal members as disclosed herein, i.e., including both an elastomeric seal body and a fabric material integrally bonded therein, may be configured differently than as illustrated While remaining within the scope of the composite seal member as disclosed herein.

While the composite seal member has been disclosed as including a fabric material, composite seal members as disclosed herein may also be formed including an elastomeric body with a plurality of fibers disposed along a desired outside surface portion of the elastomeric body, e.g., where the fibers are not necessarily provided in a woven configuration that may be considered a fabric material. The fibers useful in this regard may be the same ones that are used to form fabric materials disclosed above.

Other modifications and variations of composite seal elements and valve members including the same as disclosed herein will be apparent to those skilled in the art. It is, therefore, to be understood that within the scope of the present disclosure that composite seal elements and valve members including the same may be practiced otherwise than as specifically described.

What is claimed is:

1. A valve member comprising:
a body having a head at one end and having a circular-shaped side section extending axially from the head;
a composite seal adjacent the side section and extending circumferentially therearound, the composite seal comprising:
an elastomeric body that includes an inner diameter that is in contact with the side section and that has an outside surface extending away from the side section; and
a non-elastomeric material that is attached with at least a portion of the elastomeric body outside surface.

2. The valve member as recited in claim 1 wherein the non-elastomeric material is a fabric material.

3. The valve member as recited in claim 1 wherein the non-elastomeric material is positioned to make contact with a valve seat within a valve body.

4. The valve member as recited in claim 3 wherein the non-elastomeric material is attached along a portion of the outside surface that does not make contact with the valve seat within a valve body.

5. The valve member as recited in claim 1 wherein the non-elastomeric material has a constant thickness along the outside surface.

6. The valve member as recited in claim 1 wherein the non-elastomeric material has a thickness that is different at different locations along the outside surface.

7. The valve member as recited in claim 1 wherein the non-elastomeric material is a fabric that is integrally bonded with the elastomeric body, and when the fabric is positioned along a portion of the outside surface that makes contact with a valve seat during operation within a valve body.

8. The valve member as recited in claim 7 wherein the fabric is positioned along a portion of the outside surface that does not make contact with a valve seat during operation within a valve body.

9. The valve member as recited in claim 1 wherein the elastomeric material is urethane, and the non-elastomeric material is a fabric comprising aramid fiber.

10. The valve member as recited in claim 1 wherein non-elastomeric material covers at least 25 percent of the outside surface.

11. The valve member as recited in claim 1 wherein the non-elastomeric material has a thickness in the range of from about 0.2 to 1 mm.

12. A composite seal for use with a valve member movably disposed within a valve body, wherein the composite seal is an annular member that is attached to the valve member and is configured to form a seal when placed into contact with a valve seat in the valve body, the composite seal comprising:
an elastomeric body having an inside diameter attached to the valve member and an outside diameter having an outside surface; and
a fabric material integrally bonded to at least a portion of the elastomeric body.

13. The composite seal as recited in claim 12 wherein the fabric material is disposed along the outside surface of the elastomeric body.

14. The composite seal as recited in claim 13 wherein the composite seal element includes a further fabric material disposed in the elastomeric body.

15. The composite seal as recited in claim 12 wherein the fabric material is positioned to make contact with the valve body valve seat.

16. A valve comprising:
a valve body comprising a valve seat disposed therein; and
a valve member movably disposed within the valve body to contact the valve seat in a first position, and to be free of the valve seat in a second position, wherein the valve member includes a composite seal attached thereto comprising:
an elastomeric body including an inside diameter connected with the valve member and an outside diameter forming an outside surface of the elastomeric body; and
a non-elastomeric material attached to the outside surface of the elastomeric body and positioned to make contact with the valve seat when the valve member is operated in the valve body.

17. The valve as recited in claim 16 wherein the non-elastomeric material covers at least 25 percent of the outside surface of the elastomeric body.

18. The valve as recited in claim 16 wherein the non-elastomeric material has a thickness in the range of from about 0.2 to 1 mm.

19. The valve as recited in claim 16 wherein the non-elastomeric material is a fabric that is integrally bonded with the elastomeric body.

20. The valve as recited in claim 16 wherein the composite seal comprises an additional non-elastomeric material disposed within the elastomeric body beneath the outside surface.
